(19) United States
(12) Patent Application Publication
(10) Pub. No.: US 2023/0080795 A1
(43) Pub. Date: Mar. 16, 2023

(54) MALE MASTURBATION DEVICE

(71) Applicant: INNOVATION STREET PTE. LTD., Singapore (SG)

(72) Inventor: Praveen RAJU, Singapore (SG)

(21) Appl. No.: 17/471,952

(22) Filed: Sep. 10, 2021

(51) Int. Cl. A61H 19/00; A61H 23/04; A61H 9/00

(52) U.S. Cl. CPC A61H 19/32; A61H 23/04; A61H 9/005; A61H 2201/1695

(57) ABSTRACT

A male masturbation device, includes a soft artificial colloid set in a housing which imitates the vagina, and a cavity is provided in the artificial colloid for accommodating the penis, the outer wall of the colloid is provided with a sealed chamber, the sealed chamber is connected with an air pressure control device, and the air pressure control device draws or fills air into the sealed chamber to make the wall of the colloid producing intermittent contraction or expansion to stimulate the penis. the air pressure control device inflate or pump the sealed chamber to realize the contraction or expansion of the artificial colloid, so that the cavity of the artificial colloid can compress or relax the penis to achieve the effect of imitating the movement of female vaginal. Allow users to experience a more realistic effect and better stimulate the male reproductive organs and achieve orgasm.

### FIELD OF THE INVENTION

The Utility Model involves a sex product, especially a mal masturbation device.

### BACKGROUND OF THE INVENTION

Masturbation has the merit of independent sexual behavior, and can obtain the same physiological response as sexual intercourse. Appropriate masturbation will not cause any harm to the body, but can also make up for people who cannot have sex in life, such as unmarried young people, separated husbands and wives, divorced widows, STD patients, disabled persons, and spouses who are sick and cannot have sex. And masturbation give them greater enthusiasm and energy for work. Further, masturbation can also be used to collect semen samples for clinical examination, and healthy men can also donate their own semen through masturbation. Masturbation will not cause any sexual infectious disease, will not involve others, or be involved in infidelity in sexual behavior and emotional entanglement, and will help to decrease sexual assault or even sexual crimes, and avoids moral and social problems caused by sexual problems. Therefore, masturbation is harmless. Do not have psychological pressure to avoid feelings of guilt and self-blame. But frequent masturbation may lead to lack of concentration, fatigue, and memory loss. Therefore, it is necessary to control the frequency and intensity of masturbation

In order to meet the demand of masturbation, there are masturbation devices for men on the market. Most of the existing male masturbators are made of soft rubber to simulate the female vagina and add a vibration function to produce a stimulating effect. However, due to the simple structure and relatively single function, it is difficult to imitate the various stimuli produced during human sexual behavior, so it is not ideal.

### SUMMARY OF THE UTILITY MODEL

In view of the aforesaid drawbacks of the prior art, the present utility model provides a male masturbation device to imitate the movement of female vagina, and let it feel more realistic when used, so as to better stimulate male reproductive organs and achieve orgasm.

So, the utility model provides:

A male masturbation device, wherein includes a soft artificial colloid set in a housing which imitates the vagina, and a cavity is provided in the artificial colloid for accommodating the penis, the outer wall of the colloid is provided with a sealed chamber, the sealed chamber is connected with an air pressure control device, and the air pressure control device draws or fills air into the sealed chamber to make the wall of the colloid producing intermittent contraction or expansion to stimulate the penis.

Further, the sealed chamber is composed of the outer wall of the colloid and the inner wall of the housing; the outer wall of the colloid and the inner wall of the housing are seal connected to form the sealed chamber.

Further, the bottom of the housing is an opening, the cavity's entrance of the colloid extends to the outside of the opening, and the opening of the housing is provided with a buckle ring which protrude inward, a groove is provided on the outer wall of the colloid at the corresponding position of the ring, and the groove matches with the ring to fix the colloid in the housing and form sealing.

Further, the ring is installed at the opening of the housing by a buckle.

Further, there is space between the outer wall of the colloid and the inner wall of the housing; and the outer wall of the colloid is provided with supporting rib to fix the cavity, the supporting rib can be attached to the inner wall of the housing.

Further, a wrinkle massage section, a spiny massage section and a glans massage section are sequentially distributed in the inner wall of the cavity from the entrance.

Further, a vibration device and/or a heating device are embedded in the colloid.

Further, the vibrating device is a vibrating motor, the motor is wrapped with a heating sheet, and the motor and the heating sheet are covered with rubber outside.

Further, the top of the housing is provided with an opening, the opening is buckled with an installation chamber, the air pressure control device is fixed in the installation chamber and the inlet and outlet of the air pressure control device extends to the bottom surface of the installation chamber; the bottom surface of the installation chamber covers the opening and seals to form the sealed chamber.

Further, the installation chamber is buckled to the opening of the housing on top by a buckle, and a sealing ring is provided at the connection position of the installation chamber and the housing.

The utility model has the following advantages: the air pressure control device is used to inflate or pump the sealed chamber to realize the contraction or expansion of the artificial colloid, so that the cavity of the artificial colloid can compress or relax the penis to achieve the effect of imitating the movement of female vaginal. Let user experience a more realistic effect and better stimulate the male reproductive organs and achieve orgasm.

### BRIEF DESCRIPTION OF THE DRAWINGS

Below are explanations of the invention combining with drawings.

FIG. 1 is the perspective view of the present utility model.

FIG. 2 is an exploded view of FIG. 1.

FIG. 3 is the front view of artificial colloid.

FIG. 4 is the A-A section view of FIG. 3.

In the figures: 1. the housing, 2. the artificial colloid, 3. the cavity, 4. the sealed chamber, 5. the air pressure control device, 6. the buckle ring, 7. the groove, 8. the buckle, 9. the supporting rib, 10. the wrinkle massage section, 11. the spiny massage section, 12. glans massage section, 13. the vibration device, 14. the heating device, 15. the installation chamber, 16. the sealing ring.

### DESCRIPTION OF THE EMBODIMENTS

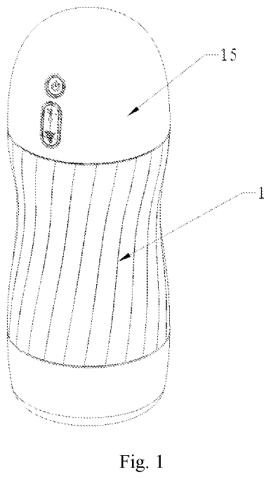

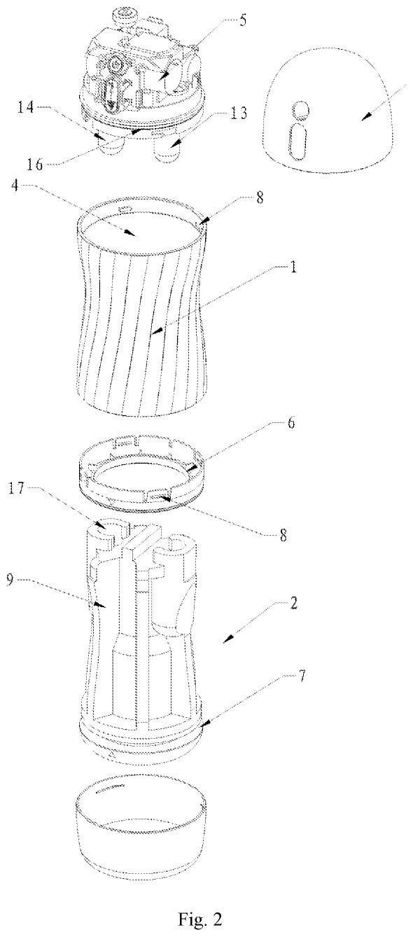

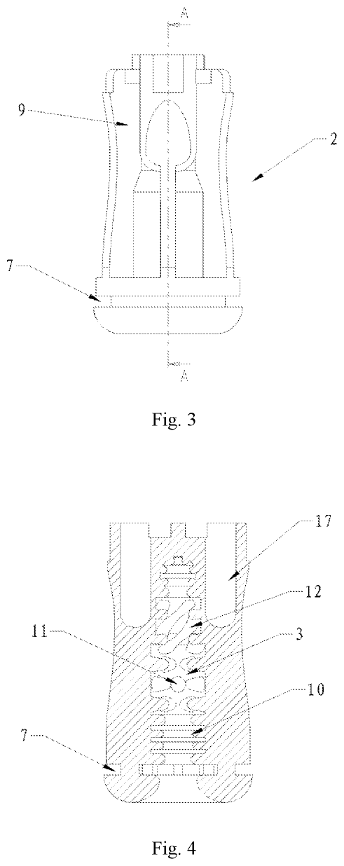

Refer to FIG. 1 and FIG. 2, the male masturbation device includes a soft artificial colloid 2 set in a housing 1 which imitates the vagina, and a cavity 3 is provided in the artificial colloid 2 for accommodating the penis. The outer wall of the colloid 2 is provided with a sealed chamber 4. The sealed chamber 4 is connected with an air pressure control device 5, and the air pressure control device 5 draws or fills air into the sealed chamber 4 to make the wall of the colloid 2 producing intermittent contraction or expansion to stimulate the penis. The artificial colloid 2 generally uses the silicone which simulates the skin, to be solidified and formed by a mold. And it imitates the structure of a female vagina, making the artificial colloid 2 closer to the female vagina by touch and practicality. The air pressure control device 5 can use the existing air pump structure, which has the functions of inflating and pumping. When the air pump is started, the sealed chamber 4 can be inflated or pumped by the control of a control circuit. When the air pump is pumped, the air pressure of the sealed chamber 4 decreases and is lower than the atmospheric pressure, and the colloid 2 expands toward the sealed chamber 4, so that the cavity 3 expands radially. On the other hand, when the air pump is inflated, the air pressure of the sealed chamber 4 increases and is higher than the atmospheric pressure, so the colloid 2 contracts to cause the cavity 3 decreasing radially. The air pressure control device inflates or pumps the sealed chamber 4 to realize the contraction or expansion of the colloid 2, so that the cavity 3 of the colloid can compress or relax the penis to achieve the effect of imitating the movement of female vaginal. Allow users to experience a more realistic effect and better stimulate the male reproductive organs and achieve orgasm.

The sealed chamber 4 can be built inside the housing 1. In order to save production costs and simplify the structure of the entire product for more easy assembly, the sealed chamber 4 is composed of the outer wall of the colloid 2 and the inner wall of the housing 1. through the outer wall of the artificial colloid 2. The sealed cavity 4 is formed in a sealed connection with the inner wall. And the outer wall of the colloid 2 and the inner wall of the housing 1 are seal connected to form the sealed chamber 4. In order to ensure the hygienic use of the colloid 2, the used colloid 2 should be able to be easily taken out so that the user can clean and disinfect the colloid 2. For this reason, the bottom of the housing 1 sets an opening, and because the artificial colloid 2 is very soft as a whole, it can be inserted or taken out of the sealed chamber 4 through the opening. At the same time, the outer wall of the colloid 2 is contact with the outer wall of the housing 1 to form sealing. Further, the cavity's 3 entrance of the colloid 2 extends to the outside of the opening, which is also convenient for the user to take it out for cleaning. In order to prevent the colloid 2 from easily falling out of the opening of the housing 1 when use, and to further improve the sealing effect of the sealed cavity 4, the opening of the housing 1 is provided with a buckle ring 6 which protrude inward. A groove 7 is provided on the outer wall of the colloid 2 at the corresponding position of the ring 6. The groove 7 matches with the ring 6 to fix the colloid 2 in the housing 1 and form sealing. In addition, the buckle ring 6 is installed at the opening of the housing 1 by a buckle 8.

There is space between the outer wall of the colloid 2 and the inner wall of the housing 1. The scale of the space is set according to the extent of expansion and contraction of the colloid 2 when use. In order to prevent the colloid 2 from swinging in the sealed chamber 4, the outer wall of the colloid 2 is provided with supporting rib 9 to fix the cavity 3. The supporting rib 9 can be attached to the inner wall of the housing 1.

For better imitating the structure of the female vagina and improve the stimulation during use, a wrinkle massage section 10, a spiny massage section 11 and a glans massage section 12 are sequentially distributed in the inner wall of the cavity 3 from the entrance. During use, the different massage sections of the cavity 3 can provide different stimuli to different parts of the penis, so as to enhance the user experience.

For further facilitating the disassembly of the product and easily taking out the colloid 2 in the sealed chamber 4, the top of the housing 1 is provided with an opening and the opening is buckled with an installation chamber 15. Moreover, the buckle structure at the bottom of the housing 1 and the buckle ring 6 are the same. That is, the whole housing 1 is a symmetrical design. Therefore, when assembling, there is no need to distinguish the top and bottom, and the buckle ring 6 is installed in one opening at one end, and then the installation chamber 15 is installed at the other end.

The air pressure control device 5, control circuit, power supply and other equipment are installed in the installation chamber 15 so that the installation chamber 15 can be separated with other parts which need to be cleaned. The air inlet and outlet of the air pump extend to the bottom surface of the installation chamber 15 through a hose. A sealing ring 16 is provided between the installation chamber 15 and the housing 1 to seal the sealed cavity 4.

In order to further enhance the experience of use, a vibration device 13 and/or a heating device 14 are embedded in the colloid 2. The vibration device 13 can be activated according to needs of the user. There are many kinds of devices on the market which can achieve vibrations, and the modes of vibrations are also different, such as rotation, swing, movement, etc. The vibration can be combined with the contraction and expansion of the colloid 2 to form more complex diverse experience. The utility model is preferably using a vibrating motor, which can simplify the structure. The vibrating motor is installed on the bottom of the installation chamber 15. The heating device 14 can heat up the colloid 2 to avoid bad experience of too low temperature of the colloid 2. The heating device 14 uses a heating film and is wrapped around the vibrating motor. The motor and the heating sheet are also covered with rubber, and the top end of the rubber extends into the installation chamber 15 to seal and fix with the installation chamber 15. The colloid 2 is provided with a hole 17 for mounting the vibration device 13 and the heating device 14. So the vibration device 13 and the heating device 14 can fully contact with the colloid 2 and the vibration and temperature can be transmitted to the colloid 2.

1. A male masturbation device, wherein includes a soft artificial colloid set in a housing which imitates the vagina, and a cavity is provided in the artificial colloid for accommodating the penis, the outer wall of the colloid is provided with a sealed chamber, the sealed chamber is connected with an air pressure control device, and the air pressure control device draws or fills air into the sealed chamber to make the wall of the colloid producing intermittent contraction or expansion to stimulate the penis.

2. The male masturbation device of claim 1, wherein the sealed chamber is composed of the outer wall of the colloid and the inner wall of the housing; the outer wall of the colloid and the inner wall of the housing are seal connected to form the sealed chamber.

3. The male masturbation device of claim 2, wherein the bottom of the housing is an opening, the cavity's entrance of the colloid extends to the outside of the opening, and the opening of the housing is provided with a buckle ring which protrude inward, a groove is provided on the outer wall of the colloid at the corresponding position of the ring, and the groove matches with the ring to fix the colloid in the housing and form sealing.

4. The male masturbation device of claim 3, wherein the ring is installed at the opening of the housing by a buckle.

5. The male masturbation device of claim 1, wherein there is space between the outer wall of the colloid and the inner wall of the housing; and the outer wall of the colloid is provided with supporting rib to fix the cavity, the supporting rib can be attached to the inner wall of the housing.

6. The male masturbation device of claim 1, wherein a wrinkle massage section, a spiny massage section and a glans massage section are sequentially distributed in the inner wall of the cavity from the entrance.

7. The male masturbation device of claim 1, wherein a vibration device and/or a heating device are embedded in the colloid.

8. The male masturbation device of claim 7, wherein the vibrating device is a vibrating motor, the motor is wrapped with a heating sheet, and the motor and the heating sheet are covered with rubber outside.

9. The male masturbation device of claim 1, wherein the top of the housing is provided with an opening, the opening is buckled with an installation chamber, the air pressure control device is fixed in the installation chamber and the inlet and outlet of the air pressure control device extends to the bottom surface of the installation chamber; the bottom surface of the installation chamber covers the opening and seals to form the sealed chamber.

10. The male masturbation device of claim 7, wherein the installation chamber is buckled to the opening of the housing on top by a buckle, and a sealing ring is provided at the connection position of the installation chamber and the housing.
